(19) United States
(12) Patent Application Publication
(10) Pub. No.: US 2025/0065759 A1
(43) Pub. Date: Feb. 27, 2025

(54) INFORMATION PROCESSING APPARATUS, SYSTEM AND METHOD

(71) Applicant: Ubiden, Inc., Tokyo (JP)

(72) Inventors: Norio Yamaguchi, Tokyo (JP); Tatsuro Shiraishi, Tokyo (JP); Shuhei Onishi, Tokyo (JP); Hitoshi Ikeda, Tokyo (JP)

(73) Assignee: Ubiden, Inc., Tokyo (JP)

(21) Appl. No.: 18/454,904

(22) Filed: Aug. 24, 2023

(51) Int. Cl. B60L 53/66; B60L 53/65

(52) U.S. Cl. CPC B60L 53/665; B60L 53/65

(57) ABSTRACT

It is facilitated to increase the number of energy output sections capable of managing a provision of energy to an energy supply target and a use of energy by the energy supply target, and to expand a disposing area of the energy output sections. The information processing apparatus acquires provision-side registration information and use-side registration information, stores the provision-side registration information and output-section identification information in association with each other, and stores the use-side registration information, supply-target identification information and information on a mobile terminal apparatus used by a user in association with each other. The information processing apparatus receives usage start information including the output-section identification information from the mobile terminal apparatus of the user, acquires energy supply information, performs a process necessary for paying to a provider with respect to a fee for providing an energy supply service from the energy output section to the energy supply target, and performs a process necessary for fee-charging to the user with respect to a usage fee of the energy supply service based on the energy supply information.

### TECHNICAL FIELD

The present invention relates to information processing apparatuses, systems and methods for managing an energy supply service that supply an energy such as an electric power.

### BACKGROUND ART

A system for managing a power supply service via an electrical outlet is conventionally known. For example, Patent Literature 1 discloses a system provided with a power-supply gate apparatus that controls a power supply, a server apparatus (information processing apparatus) that manages usage fees for power supplied from the power-supply gate apparatus, a mobile outlet (energy output section) that connects the power-supply gate apparatus and an electric vehicle (energy supply target). The mobile outlet is equipped with a power usage integrator (detection section) for measuring how much electric power the electric vehicle uses. After the electric power from the power-supply gate apparatus is output from the mobile outlet and supplied to the electric vehicle, a current power supply amount (energy supply information) detected by the power usage integrator is transmitted from the mobile outlet to the server apparatus, and then the server apparatus calculates a usage fee of the electric power from the received power supply amount.

### CITATION LIST

### Patent Literature

Patent Literature 1: Japanese Unexamined Patent Application Publication No. 2002-325357.

### SUMMARY OF INVENTION

### Technical Problem

In recent years, there is a demand for an increase in the number of energy output sections that can manage a provision of the energy to energy-supply targets such as electric vehicles and a use of the energy by the energy supply targets, as well as an expansion of a disposing area where the energy output sections are disposed. However, due to various constraints, it is difficult to increase the number of energy output sections and expand the disposing area thereof.

### Solution to Problem

An information processing apparatus according to an aspect of the present invention is an information processing apparatus for managing an energy supply service. This information processing apparatus comprises a provision-side registration-information acquisition section for acquiring provision-side registration information that includes information on a provider who owns or manages an energy output section capable of being used for the energy supply service and information on the energy output section, a use-side registration-information acquisition section for acquiring use-side registration information that includes information on a user who uses, owns, or manages an energy supply target capable of using an energy supplied by the energy supply service and information on the energy supply target, a storage section for storing the provision-side registration information and output-section identification information for identifying the energy output section in association with each other, and storing the use-side registration information, supply-target identification information for identifying the energy supply target, and information on a mobile terminal apparatus used by the user during a use of the energy supply service in association with each other, a usage-start-information receiving section for receiving usage start information that includes the output-section identification information corresponding to the energy output section that supplies the energy to the energy supply target from the user's mobile terminal apparatus at the time of starting the use of the energy supply service, a supply-information acquisition section for acquiring energy supply information regarding an energy supply to the energy supply target of the user from the energy output section of the provider when the energy supply service is used, a payment processing section for referring to information stored in the storage section based on the energy supply information acquired by the supply-information acquisition section, and performing a process necessary for paying to the provider with respect to a fee for providing the energy supply service from the energy output section to the energy supply target, and a fee-charge processing section for referring to information stored in the storage section based on the energy supply information acquired by the supply-information acquisition section, and performing a process necessary for fee-charging to the user with respect to a usage fee of the energy supply service from the energy output section to the energy supply target.

In the foregoing information processing apparatus, the energy output section may receive the energy from an energy business-operator to which an energy fee is paid from the provider, based on a total amount of an amount of the energy supplied from the energy output section to the energy supply target and an amount of the energy supplied from other than the energy output section to other supply targets other than the energy supply target, and may supply the energy to the energy supply target.

In the foregoing information processing apparatus, the supply-information acquisition section may acquire, as the energy supply information, at least use-side identification information of a side that uses the energy, provision-side identification information of a side that provides the energy, and variable parameter information that vary the fee for providing and the usage fee.

In the foregoing information processing apparatus, the supply-information acquisition section may receive and acquire the variable parameter information from a management apparatus that manages the energy supply target.

In the foregoing information processing apparatus, the supply-information acquisition section may receive and acquire the variable parameter information from the energy supply target.

In the foregoing information processing apparatus, the supply-information acquisition section may receive and acquire the variable parameter information from an energy output apparatus including the energy output section.

In the foregoing information processing apparatus, the supply-information acquisition section may receive and acquire the use-side identification information and the provision-side identification information from the user's terminal apparatus.

A system according to another aspect of the present invention is a system for managing an energy supply service. This system comprises the foregoing information processing apparatus and a transmission apparatus for transmitting the energy supply information acquired by the supply-information acquisition section of the information processing apparatus, to the information processing apparatus.

A method according to still another aspect of the present invention is a method for managing an energy supply service. This method comprises acquiring provision-side registration information that includes information on a provider who owns or manages an energy output section capable of being used for the energy supply service and information on the energy output section, acquiring use-side registration information that includes information on a user who uses, owns, or manages an energy supply target capable of using an energy supplied by the energy supply service and information on the energy supply target, storing the provision-side registration information and output-section identification information for identifying the energy output section in association with each other, and storing the use-side registration information, supply-target identification information for identifying the energy supply target, and information on a mobile terminal apparatus used by the user during a use of the energy supply service in association with each other, receiving usage start information that includes the output-section identification information corresponding to the energy output section that supplies the energy to the energy supply target from the user's mobile terminal apparatus at the time of starting the use of the energy supply service, acquiring energy supply information regarding an energy supply to the energy supply target of the user from the energy output section of the provider when the energy supply service is used, referring to the stored information based on the energy supply information, and performing a process necessary for paying to the provider with respect to a fee for providing the energy supply service from the energy output section to the energy supply target, and referring to the stored information based on the energy supply information, and performing a process necessary for fee-charging to the user with respect to a usage fee of the energy supply service from the energy output section to the energy supply target.

### Advantageous Effects of Invention

According to the present invention, it is possible to easily increase the number of energy output sections that can manage the provision of energy to the energy supply target and the use of energy by the energy supply target, and easily expand the disposing area thereof.

### BRIEF DESCRIPTION OF DRAWINGS

FIG. 1 is an explanatory diagram showing a service management system according to an embodiment.

FIG. 2 is an explanatory diagram showing an example of a main configuration of the service management system according to the embodiment.

Each of FIGS. 3(a) to 3(c) is an explanatory diagram showing an example of an image attached to an electrical outlet in the embodiment.

FIG. 4 is a block diagram showing an example of a configuration of main functions of a service management server in the service management system according to the embodiment.

FIG. 5 is a flowchart illustrating an example of a service management process in the service management server 100 according to the embodiment.

FIG. 6 is an explanatory diagram showing an example of a main configuration of a service management system according to a modified example.

### DESCRIPTION OF EMBODIMENTS

Hereinafter, an embodiment of the present invention will be described with reference to the drawings.

A system according to the embodiment is a system that manages an energy supply service from an energy output section to an energy supply target. The energy output section is, for example, owned or managed by a provider that provides an energy in the energy supply service. The supplied energy may be, for example, a primary energy in the form of oil, natural gas, coal, or the like, or a secondary energy in the form of electricity, hydrogen, gasoline, light oil, heavy oil, city gas, alcohol, or the like.

The energy supply target to which the energy is supplied is, for example, an electric moving body driven by a battery-mounted motor. The moving body may be a moving body moving on the ground such as an electric vehicle or a fuel cell vehicle, a moving body moving through the air such as a drone, or a moving body such as a ship moving on water such as the sea. The moving body may be a vehicle having four or more wheels, a three-wheeled vehicle (tricycle), a two-wheeled vehicle (motorcycle, bicycle), a truck, a bus, a private vehicle, a commercial vehicle, or the like. The energy supply target is, for example, something used, owned, or managed by a user of the energy supply service. The energy supply target may be leased from a leasing business-operator, or may be owned by a business-operator different from the user. Further, the energy supply target may be an electric device or an electronic device such as a portable or stationary home appliance, an office device and a communication terminal apparatus.

In the following embodiments, as an example, a case is described in which an energy to be supplied is an electric energy, an energy output section that outputs the energy is an electrical outlet that outputs an electrical energy, an energy supply target to which the energy is supplied is a vehicle or a battery which is installed in the vehicle, and a system is a service management system that manages an electrical charging service (energy supply service) for electrically charging the battery of the vehicle with the electric power output from the electrical outlet.

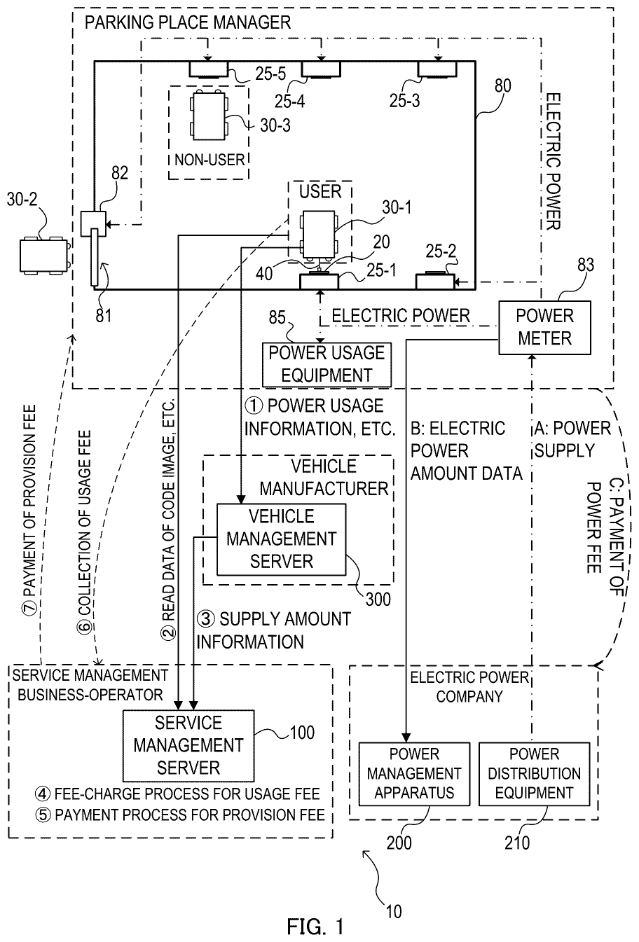

FIG. 1 is an explanatory diagram showing a service management system 10 according to the present embodiment.

This service management system 10 manages the electrical charging service that charges the battery of the vehicle from an electrical outlet 20 within an area of a parking place 80 having parking spaces where a plurality of vehicles 30-1 to 30-3 can be parked. A location where the vehicles 30-1 to 30-3 enter and exit the parking place 80 is one entrance/exit gate 81. A gate apparatus 82 is disposed at the entrance/exit gate 81 of the parking place 80.

In the parking place 80, each of power-charging stands 25-1 to 25-5, which includes an electrical outlet 20, is disposed near the parking space. In the example of FIG. 1, although five power-charging stands 25-1 to 25-5 are disposed in the parking place 80, the number of power-charging stands disposed in the parking place is arbitrary, and may be one or more.

The five charging stations 25-1 to 25-5 in the parking place 80 receive the electric power via a power line from a power distribution equipment 210 of a same electric power company as an energy business-operator (Step A), and a power supply amount is measured by a single power meter 83 that is managed by the electric power company. Therefore, in the present embodiment, the configuration is such that the amount of electric power supplied from the five charging stations 25-1 to 25-5 cannot be measured separately for each charging station.

Additionally, this power meter 83 measures the amount of electric power supplied to the charging stations 25-1 to 25-5 as well as the gate apparatus 82 and various power usage equipment 85 that use power. Therefore, in the present embodiment, the configuration is such that the power supply amount at the charging stations 25-1 to 25-5 and the power supply amount at the other power usage equipment 82 and 85 cannot be measured individually.

The power supply amount (electric power amount data) measured by the power meter 83 is sent to a power management apparatus 200 of the electric power company (step B). For example, if the power meter 83 is equipped with a communication function, such as a smart meter, the electric power amount data is transmitted to the power management apparatus 200 of the electric power company via a communication line.

The power usage equipment (charging stations 25-1 to 25-5, gate apparatus 82, power usage equipment 85) whose power supply amount is measured by the power meter 83 is managed by the parking place manager (disposer of the electrical outlet 20) as the provider. Therefore, an electric power fee (energy fee) for the amount of electric power supplied by the electric power company and used by such power usage equipment 25-1 to 25-5, 82, and 85 is paid by the parking place manager to the electric power company (Step C).

The electric power fee paid by the parking place manager to the electric power company can be covered by, for example, the parking fee collected by the parking place manager from parking place users who use the parking place. This electric power fee includes a fee for the amount of electric power supplied to the vehicle 30-1 from the charging stations 25-1 to 25-5, but the parking place users who use the parking place also includes non-users who do not use the power-charging stands 25-1 to 25-5 (such as users of vehicles without a charging function). Further, even for users who use the charging stations 25-1 to 25-5, the amount of electric power supplied from the charging stations usually differs. Therefore, it is unfair and undesirable for the parking place users to collect a flat fee by adding the electric power fee that is paid by the parking place manager to the electric power company on top of the parking place fees of the parking place users.

The service management system of the present embodiment collects the usage fee from the user who receives the electric power supplied from the charging stations 25-1 to 25-5, and manages the electrical charging service that pays a fee (provision fee) for the amount of electric power supplied to the user to the parking place manager (provider). According to this service management system, among the electric power fee paid by the parking place manager to the electric power company, the electric power fee for the amount of electric power supplied from the charging stations 25-1 to 25-5 can be covered by the provision fee paid by the electrical charging service.

Furthermore, in the service management system of the present embodiment, the user who receives the electric power supplied from the charging stations 25-1 to 25-5 are fee-charged the usage fee according to the power supply amount. Therefore, an appropriate usage fee can be collected from the user of the charging stations 25-1 to 25-5 according to the amount of electric power supplied to the user.

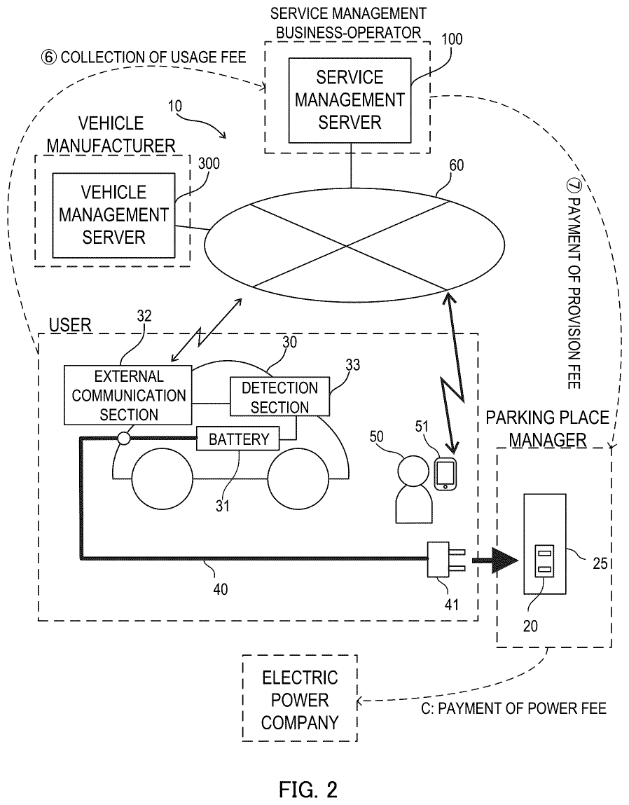

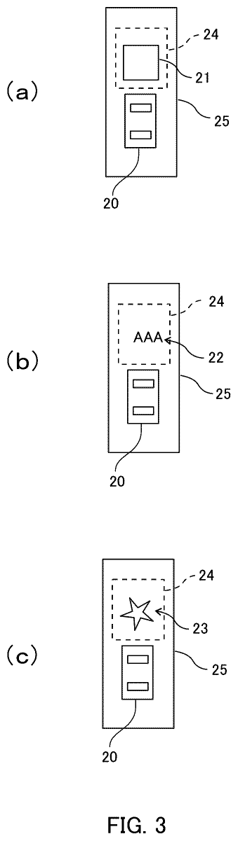

FIG. 2 is an explanatory diagram showing an example of a main configuration of the service management system 10 according to the present embodiment.

In FIG. 2, the service management system 10 manages the provision and use (electrical charging service) of the electric power to the supply target to which the electric power is supplied from the electrical outlet 20. The supply target in the present embodiment is the vehicle 30 or the battery 31 of the vehicle 30 that is charged with the electric power from the electrical outlet 20. The electric power is supplied from the electrical outlet 20, for example, via a wired power cable 40 and a plug 41. The electric power may be supplied from the electrical outlet 20 by a wireless power supply such as an electromagnetic induction, a power supply by a radio wave such as a microwave and a power supply by a light such as a laser light. Further, the voltage (current) supplied from the electrical outlet 20 may be alternating current or direct current.

The service management system 10 includes a service management server 100 as an information processing apparatus that manages the provision and use (electrical charging service) of the electric power (electrical energy). The service management server 100 may be configured with a single computer apparatus, may be configured with a plurality of computer apparatuses cooperated with each other, or may be configured with a cloud system on a network.

The electrical outlet 20 as an energy output section capable of outputting an electric power (electrical energy) may be a general-purpose outlet with no limitation of use, or may be a dedicated outlet with a limitation of use. Further, the electrical outlet 20 may be an electrical outlet for which a user is not limited, or an electrical outlet that can be used only by a specific user.

Each of FIGS. 3(a) to 3(c) is an explanatory diagram showing an example of an image attached to the electrical outlet 20 in the present embodiment.

A code image (for example, an image of a QR Code (registered trademark)) 21 is attached to the electrical outlet 20 in FIG. 3(a). The code image 21 may be a one-dimensional code image or a two-dimensional code image. The code image 21 is an image in which information such as a name, an identification number, a disposed location, and a disposing entity (parking place manager) of the electrical outlet 20 is encoded.

The electrical outlet 20 in FIG. 3(b) has an image of characters (for example, handwritten characters) 22 arbitrarily attached by the parking place manager or the like as an identification auxiliary image of the electrical outlet 20. Also, the electrical outlet 20 in FIG. 3(c) has an image of an illustration 23 arbitrarily attached by the parking place manager or the like as the identification auxiliary image. The characters 22 or the illustration 23 may be attached to the electrical outlet 20. The characters 22 and illustration 23 of the electrical outlet 20 may be drawn on a seal member 24 by the parking place manager or the like and pasted on a side of the electrical outlet 20. It is noted that the identification auxiliary image may be a pattern or a mark in addition to the characters and the illustrations.

The terminal apparatus 51 of the user 50 who wishes to use the electric power supplied from the electrical outlet 20 can communicate with the service management server 100 via a communication network 60 such as a mobile communication network or the Internet. The terminal apparatus 51 includes an operation section such as keys, buttons and a touch panel, a display section such as a liquid crystal display, an imaging section such as a camera that captures the code image, the identification auxiliary image, etc. of the electrical outlet, and the like. The terminal apparatus 51 can start and execute a pre-installed predetermined power usage application (power usage app) by a user's operation. The terminal apparatus 51 may include a current-location acquisition section such as a GNSS receiver that acquires information about its current location. The terminal apparatus 51 is, for example, a mobile station (also referred to as a “mobile device”, a “user equipment (UE)”, etc.) that can communicate via a mobile communication network of the fourth generation, the fifth generation, or later generations.

The vehicle 30 can communicate with the service management server 100 of a service management business-operator and a vehicle management server 300 of a vehicle manufacturer via the communication network 60 using an external communication section 32 of the in-vehicle apparatus. It is noted that the external communication section 32 may separately include a communication section that communicates with the service management server 100 and a communication section that communicates with the vehicle management server 300.

The external communication section 32 may be, for example, a remote control unit (TCU: Telematics Control Unit) connected to an in-vehicle network (CAN: Controller Area Network) via a gateway. The remote control unit (TCU) may have a short-range wireless communication function such as a wireless LAN or Bluetooth (registered trademark) in addition to a communication function via the communication network 60. The in-vehicle network (CAN) is connected to a battery management system (BMS) that manages the battery 31 and one or more electronic control units (ECU) that control other parts, in addition to the remote control unit (TCU).

Next, a flow of the electrical charging service managed using the service management system 10 according to the present embodiment will be explained.

Power usage information (for example, battery identification information, amount of electric power, power-charging start time, power-charging end time), which is energy supply information regarding the power supply related to charging of the battery 31, is transmitted from the battery management system (BMS) via the remote control unit (TCU) to the vehicle management server 300 of the vehicle manufacturer (Step 1). In addition, vehicle identification information, which is use-side identification information on a side that uses the electric power, is transmitted from the electronic control unit (ECU) having a memory that stores basic information of the vehicle, via the remote control unit (TCU) to the vehicle management server 300. The transmission of such information to the vehicle management server 300 is performed, for example, based on a timing specified by the vehicle management server 300 and the like, or based on a transmission request generated by an application running on the terminal apparatus 51. The transmission request from the terminal apparatus 51 may be received by the remote control unit (TCU) of the vehicle, for example, via the short-range wireless communication such as the wireless LAN or Bluetooth (registered trademark). In the vehicle management server 300 of the vehicle manufacturer, the power usage information of the vehicle 30 is stored in association with the identification information of the vehicle 30, and the latest power usage information is managed almost in real time.

On the other hand, when the user 50 parks the vehicle 30-1 in the parking place 80 and charges the battery of the vehicle 30-1 from the electrical outlet 20 of the charging station 25-1, the user 50 uses the terminal apparatus 51 to execute the power usage application and to read the code image (for example, the QR Code (registered trademark) image) 21 (referring FIG. 3(a)) attached to this electrical outlet 20. Then, the user 50 operates the terminal apparatus 51 to transmit a read data of the code image 21, which is the provision-side identification information of a side that provides the electric power, and the use-side identification information from the terminal apparatus 51. The use-side identification information includes, for example, identification information of the user 50 or the terminal apparatus 51, and identification information of the supply target to which the electric power is supplied from the electrical outlet 20 (for example, identification information of the vehicle 30 or the battery 31). Such information is received by a terminal communication section 101 of the service management server 100 via the communication network 60 (Step 2).

The use-side identification information, such as the identification information of the user 50 or the terminal apparatus 51, and the identification information of the supply target (for example, the identification information of the vehicle 30 or the battery 31), may be registered in advance in the power usage application of the terminal apparatus 51, for example. The read data of the code image 21 as the provision-side identification information may be, for example, image data obtained by capturing the code image 21 with a camera of the terminal apparatus 51, or may be data obtained by decoding the image data. In addition, as the provision-side identification information, instead of the read data of the code image 21, a read data of the identification auxiliary image 22 or 23 attached to the electrical outlet 20 (referring FIG. 3(b) and FIG. 3(c)), and the location information of the terminal apparatus 51 may be used. The location information of the terminal apparatus 51 is, for example, the location information (latitude, longitude, altitude) of the terminal apparatus 51 measured by the GNSS receiver of the terminal apparatus 51.

It is noted that examples of the provision-side identification information are not limited to those described above. For example, the power-charging stand 25 provided with the electrical outlet 20 may be provided with an RF tag that stores the identification information of the electrical outlet 20. In this case, the user 50 uses the terminal apparatus 51 to execute the power usage application, and to communicate wirelessly with this RF tag, and then to acquire the identification information of the electrical outlet 20 stored in the RF tag. Then, the user 50 operates the terminal apparatus 51 to transmit the identification information of the electrical outlet 20, which is the provision-side identification information, from the terminal apparatus 51 to the service management server 100 via the communication network 60.

In the present embodiment, although the use-side identification information and the provision-side identification information described above are transmitted from the terminal apparatus 51 of the user 50 to the service management server 100 via the communication network 60, it is not limited to this. For example, a communication apparatus such as an IoT communication module is installed in the power-charging stand 25 equipped with the electrical outlet 20, and the communication apparatus communicates with the terminal apparatus 51 of the user 50 via the communication network, thereby the identification information and the provision-side identification information may be acquired from the terminal apparatus 51, and transmitted to the service management server 100 via a communication network.

Next, the service management server 100 of the service management business-operator receives the read data of the code image 21 from the terminal apparatus 51 of the user 50 and the like, and also acquires the power usage information including supply amount information, which is variable parameter information as energy supply information from the vehicle management server 300 of the vehicle manufacturer (step 3). The supply amount information is information regarding the amount of electric power supplied from the electrical outlet 20 to the vehicle 30, as the supply target, of the user 50.

Then, the service management server 100 performs a process (fee-charge process for the usage fee) necessary for collecting the usage fee for the power supply amount according to charging the vehicle 30-1 from the user 50, based on the supply amount information included in the acquired power usage information (Step 4). Thereby, the service management business-operator that operates the electrical charging service can collect the usage fee for the power supply amount according to charging the vehicle 30-1 from the user 50 (step 6).

The fee-charge process (a process necessary for fee-charging) performed by the service management server 100 is at least part of a series of processes (including all known fee-charge processes) necessary for collecting the usage fee for the power supply amount according to charging the vehicle 30-1 from the user 50, based on the acquired supply amount information. Specific examples include, for example, a process including a process of calculating the usage fee for the power supply amount according to charging the vehicle 30-1 from the acquired supply amount information, a process of performing a procedure for fee-charging the user with the usage fee, a process of providing at least one of the supply amount information and information of the usage fee to a management apparatus managed by another business-operator that collects the usage fee from the user, and the like.

In addition, when the service management server 100 receives the read data of the code image 21 and the like from the terminal apparatus 51 of the user 50 based on the acquired supply amount information, it charges a process (preparation process for payment of the provision fee) necessary for paying the provision fee for the power supply amount according to charging the vehicle 30-1 to the parking place manager (Step 5). Thereby, the service management business-operator that operates the electrical charging service can pay the provision fee for the power supply amount according to charging the vehicle 30-1 to the parking place manager (step 7).

A payment process (process necessary for payment) performed by the service management server 100 is at least part of a series of processes (including all known payment processes) necessary for paying the provision fee for the power supply amount according to charging the vehicle 30-1 to the parking place manager based on the acquired supply amount information. Specific examples include, for example, a process including a process of calculating the provision fee for the power supply amount according to charging the vehicle 30-1 from the acquired supply amount information, a process of performing a procedure for paying the provision fee to the parking place manager (provider), a process of providing at least one of the supply amount information and information of the provision fee to the management apparatus managed by another business-operator that pays the provision fee to the parking place manager, and the like.

In the present embodiment, although the supply amount information regarding the amount of electric power (energy supply amount) supplied from the electrical outlet 20 (energy output section) to the battery 31 (energy supply target) of the vehicle 30 is used as the variable parameter information for varying the provision fee and the usage fee, it is not limited to this. For example, in a case that the provision fee and the usage fee are varied according to the charging time (power-charging end time—power-charging start time), information on the charging time can be used as the variable parameter information. In this case, since there is no need for a detection section that detects the amount of electric power supplied during charging, it is possible to provide the service management system with a simple configuration.

Furthermore, for example, some of the electrical outlets 20 have different power supply speeds (amount of electric power supplied per unit time) to the vehicle 30. That is, some electrical outlets 20 are capable of a fast-charging in which a power supply speed is faster than other electrical outlets 20. In such a case, the provision fee and the usage fee may be varied depending on the difference in the power supply speed (energy supply speed) during charging (for example, whether it is the fast-charging or not), and in this case, information on the power supply speed (amount of power supplied per unit time) can be used as the variable parameter information.

In this case, it is possible to correct an inequality among the users due to differences in the power supply speeds (such as whether or not charging can be completed in a short time), and it is possible to provide the electrical charging service that gives a sense of equality to the users. In addition, it is possible to correct an inequality among the parking place managers due to differences in the power supply speeds (such as whether or not they use a fast-charging electrical outlet that requires an expensive capital investment), and it is possible to provide the electrical charging service that gives a sense of equality to the parking place managers. Particularly, it is possible to create a way for appropriately recovering the investment for the parking place manager who has invested an expensive facility for the electrical outlet 20 that is capable of the fast-charging.

The power supply speed may also vary depending on the difference in a configuration of the vehicle 30 and battery 31 as the energy supply target. Specifically, the power supply speed may vary depending on an AC power consumption rate (power consumption) of the vehicle, a battery capacity, a remaining battery level, a degree of battery deterioration (mileage of the vehicle 30, usage time of the battery 31, etc.), a charging efficiency, a location of the vehicle (region where the vehicle 30 is charged), the remaining amount of gasoline for plug-in hybrid vehicles, etc. Therefore, such information may be acquired as the variable parameter information to figure out the difference in the power supply speed, and then the usage fee to be fee-charged to the user and the provision fee to be paid to the parking place manager may be calculated. It is noted that such information can be obtained, for example, by acquiring information on the type of the vehicle 30 (energy supply target), which will be described later.

Furthermore, for example, some electrical outlets 20 have different types of output power (energy) generation methods. These types include, for example, a type recommended by a national energy policy, a type with low generation costs, and the like. Thus, when there are different types of the output power (energy) generation methods, the provision fee and the usage fee may be varied depending on the difference in the type of the power (energy) generation method, in this case, information on the type of the power (energy) generation method can be used as the variable parameter information.

It is noted that a specific example of the type of the output power (energy) generation method includes a method type capable of being distinguished as being a type in which a power source for generating the electric power is of a type of power source that generates the electric power from a fossil fuel such as an oil or a coal, or a method type in which a power source for generating the electric power is of a type of power source that generates the electric power from a natural energy such as a wind power, sunlight or a biomass (biological resource). It may be a method type capable of being distinguished as being a method type in which the foregoing type of the fossil fuel or the natural energy is further differentiated in detail (for example, in a case of the natural energy, a method type in which the wind power, the sunlight, and the biomass (biological resource) can be differentiated). The type may be determined, for example, based on the presence or absence of a certificate (such as a Green Power Certificate) issued by a predetermined certification authority. The type of the output power (energy) generation method is not limited to the type of the power source as described above, and may be a method in which the amount of CO₂ (carbon dioxide) generated in a power generation process is differentiated.

It is noted that the type of the power generation method corresponding to each electrical outlet 20 can be associated with each electrical outlet 20 in advance, for example, based on a request from the parking place manager. Specifically, in a storage section 104 of the service management server 100, information on the type of the power generation method corresponding to the electrical outlet 20 (for example, information on the presence or absence of the Green Power Certificate) is stored corresponding to the provision-side identification information such as the identification information of the electrical outlet 20.

There may be a case that, for example, the electrical outlets 20 in the system of the present embodiment may be of different types in which the type of vehicle 30 (energy supply target) to which the output electric power is supplied is different from each other. This vehicle type includes, for example, a manufacturer and a model of the vehicle 30, or a manufacturer and a model of the battery 31 installed in the vehicle 30. Thus, when the types of vehicles 30 are different from each other, the power supply speed may be different, and a cost for the power supply (an equipment cost of the electrical outlet 20) may be different. In such a case, the provision fee and the usage fee may be varied depending on the difference in the type of vehicle 30 receiving the power supply (energy supply target), and in this case, information on the type of the vehicle 30 (energy supply target) may be used as the variable parameter information. It is noted that the type of vehicle 30 that receives the power supply from each electrical outlet 20 can be determined, for example, by the service management server 100 based on vehicle identification information of the vehicle 30 transmitted from the external communication section 32 of the vehicle 30.

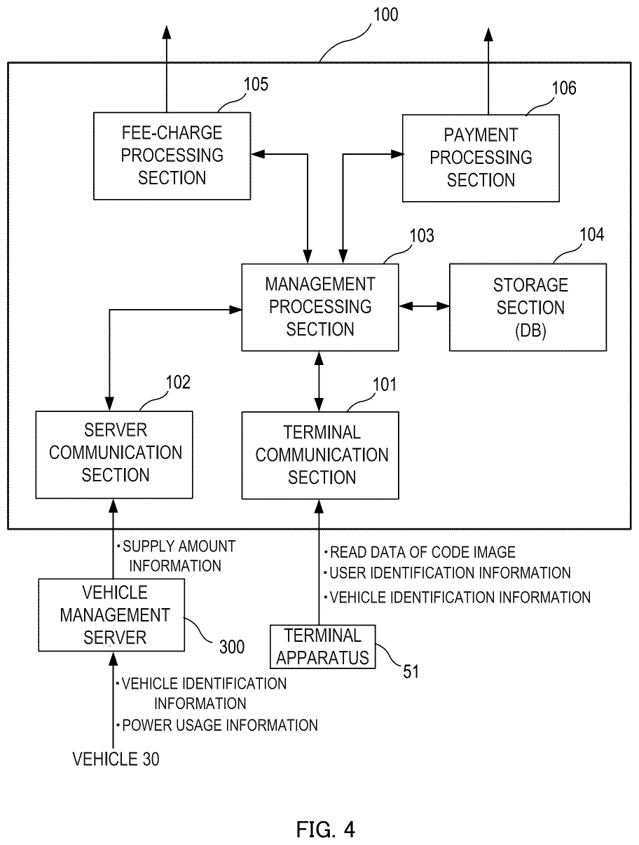

FIG. 4 is a block diagram showing an example of a configuration of main functions of the service management server 100 according to the embodiment.

In FIG. 4, the service management server 100 includes the terminal communication section 101 and a server communication section 102 as supply-information acquisition sections, a management processing section 103, the storage section (DB: database) 104, a fee-charge processing section 105, and a payment processing section 106.

The terminal communication section 101 communicates with the terminal apparatus 51 of the user 50 via the communication network 60. The terminal communication section 101 receives, for example, the read data of the code image 21 transmitted from the terminal apparatus 51, the identification information of the user 50 or the terminal apparatus 51, the identification information of the supply target to which the electric power is supplied from the electrical outlet 20 (for example, the identification information of the vehicle 30 or the battery 31), etc.

The read data of the code image 21 functions as the identification information (provision-side identification information) of the parking place manager who is the provider of the electrical outlet 20 that supplies the electric power to the vehicle 30 of the user 50, also the identification information of the user 50 or the terminal apparatus 51 and the identification information of the supply target (for example, the identification information of the vehicle 30 or the battery 31) function as the use-side identification information. Therefore, the terminal communication section 101 functions as the supply-information acquisition section.

The server communication section 102 communicates via the communication network 60 with the vehicle management server 300 of the vehicle manufacturer to which the vehicle 30 as the supply target is registered. The server communication section 102 receives, for example, at least supply amount information (variable parameter information) of the power usage information of the vehicle 30 stored by the vehicle management server 300 from the vehicle management server 300 via the communication network 60.

It is noted that the terminal communication section 101 and the server communication section 102 may be configured as an integrated communication apparatus (for example, a mobile communication module).

The management processing section 103 performs at least one of an authentication (user authentication) of the user who uses the electric power and an authentication (supply target authentication) of the supply target (for example, vehicle 30 or battery 31), based on the identification information of the user 50 or the terminal apparatus 51 and the identification information of the supply target (for example, the identification information of the vehicle 30 or the battery 31).

For example, the management processing section 103 compares the identification information (user ID) of the user 50 received from the terminal apparatus 51 and the identification information (user ID) of the user registered in advance in the service management server 100, and thereby performs the user authentication that confirms whether the user 50 is an authorized regular user registered in advance in the service management system of the present embodiment. In this case, a use of the electrical charging service may be permitted when the user is the authorized regular user, and the use of the electrical charging service may be restricted (for example, use may be prohibited) when the user is not the authorized regular user.

Further, for example, the management processing section 103 compares the identification information (for example, the identification information of the vehicle 30 or the battery 31) of the supply target received from the terminal apparatus 51 and the identification information (for example, the identification information of the vehicle 30 or the battery 31) of the supply target registered in advance in the service management server 100, and thereby performs the supply target authentication that confirms whether the supply target (for example, vehicle 30 or battery 31) is an authorized supply target registered in advance in the service management system of the present embodiment. In this case, a use of the electrical charging service may be permitted when the supply target is the authorized supply target, and the use of the electrical charging service may be restricted (for example, use may be prohibited) when the supply target is not the authorized supply target.

Furthermore, the management processing section 103 acquires by receiving the supply amount information of the supply target from the vehicle management server 300 of the vehicle manufacturer via the server communication section 102 based on the identification information (for example, the identification information of the vehicle 30 or the battery 31) of the supply target received from the terminal apparatus 51 (step 3).

As described above, the supply amount information is information regarding the amount of electric power supplied from the electrical outlet 20 to the vehicle 30 as the supply target of the user 50. The supply amount information may be any information that can specify the amount of electric power supplied from the electrical outlet 20 to the vehicle 30 as the supply target of the user 50. In the present embodiment, this supply amount information is included in the power usage information transmitted from the vehicle 30 to the vehicle management server 300, and is stored in the vehicle management server 300.

A specific example of the supply amount information is, for example, information that can be detected by a detection section 33 provided in the vehicle 30, and as long as information corresponding to the amount of electric power (power supply amount) that is supplied from the electrical outlet 20 and used to charge the battery 31, the detected information can be used as the supply amount information.

Furthermore, for example, if the detection section 33 provided in the vehicle 30 is capable of detecting a remaining power amount of the battery 31, information on the detected remaining power amount may be used as the supply amount information. In this case, for example, the amount of electric power (power supply amount) that is supplied from the electrical outlet 20 and used to charge the battery 31 can be obtained by subtracting the remaining power amount before charging from the remaining power amount after charging.

Moreover, since many electric vehicles are equipped with the detection section 33 that detects a power-charging rate (SoC: State of Charge) of the battery 31, SoC data may be used as the supply amount information. In this case, unless a full charge capacity of the battery 31 is known, the remaining power amount of the battery 31 cannot be determined from the SoC data. However, by storing a correspondence relation between the identification information of the battery 31 and the full charge capacity in the storage section (DB) 104, the full charge capacity can be specified from the identification information of the battery 31, and the remaining power amount of the battery 31 can be calculated from the SoC data of the battery 31.

The storage section (DB) 104 stores information and data necessary for various processes performed by the service management server 100. Specifically, the read data of the code image as output-section identification information, the identification information of the user 50 or the terminal apparatus 51 and the identification information of the supply target received by the terminal communication section 101, and the supply amount information received by the server communication section 102 are stored in association with each other. For example, as shown in Table 1, for each series of power usage transactions, one record is stored in which an electrical outlet ID, a user ID, a terminal ID (for example, IMEI), a vehicle ID, and the power supply amount are associated with each other, thereby a power usage transaction table (power usage register) is formed.

TABLE 1

| Outlet | User | | Vehicle | Power Supply |
|---|---|---|---|---|
| ID | ID | Terminal ID (IMEI) | ID | Amount |
| 00001 | 00001 | AA-BBBBBB-000001-D | 00001 | 10 kWh |
| 00011 | 00002 | AA-BBBBBB-000002-D | 00100 | 12 kWh |
| . . . | . . . | | . . . | . . . |

Additionally, the storage section (DB) 104 stores various tables used for managing electrical charging services via a plurality of electrical outlets. For example, the storage section (DB) 104 stores an electrical outlet management table shown in Table 2, a user management table shown in Table 3, and a vehicle management table shown in Table 4. It is noted that Table 2 may be an example in which the read data of the identification auxiliary image 22 or 23 attached to the electrical outlet 20 and the location information of the terminal apparatus 51 are used instead of the read data of the code image 21. In addition, the storage section (DB) 104 may further store the disposer (provider) management table for managing the disposer (provider) of the electrical outlet 20, such as the parking place manager. In the disposer (provider) management table, for example, information such as a name or a title, an address, etc. of the disposer (provider) is recorded using a disposer ID as a key.

TABLE 2

| Outlet | | Disposer | Code Image | Registration | |
|---|---|---|---|---|---|
| ID | Name | ID | Read Data | Date | . . . |
| 00001 | AAAAA | 00001 | ***** | 2019 Jun. 1 | . . . |
| 00002 | BBBBB | 00002 | ****** | 2019 Jun. 1 | . . . |
| . . . | . . . | . . . | . . . | . . . | . . . |

TABLE 3

| User | | Registration | |
|---|---|---|---|
| ID | Terminal ID (IMEI) | Date | . . . |
| 00001 | AA-BBBBBB-000001-D | 2019 May 1 | . . . |
| 00002 | AA-BBBBBB-000002-D | 2019 May 10 | . . . |
| . . . | . . . | . . . | . . . |

TABLE 4

| Vehicle | Battery | Registration | |
|---|---|---|---|
| ID | ID | Date | . . . |
| 00001 | AAAAA | 2019 May 1 | . . . |
| 00002 | AAAAB | 2019 May 10 | . . . |
| . . . | . . . | . . . | . . . |

A new record is added respectively to the electrical outlet management table, the user management table, and the vehicle management table when the electrical outlet 20, the user 50 (terminal apparatus 51), and the vehicle 30 (battery 31) for using the electrical charging service provided by the service management server 100 of the present embodiment are newly registered.

In addition, the storage section (DB) 104 stores a payment processing table in which provider information such as the disposer ID (identification information of the parking place manager) and information (bank account number of payee, etc.) used in a process (payment process) necessary for paying the provision fee for the power supply amount to the parking place manager is associated with information of the energy output section such as a name of the corresponding electrical outlet and the read data of the corresponding code image. A record is added to this payment processing table when the disposer (provider) of the electrical outlet 20 is newly registered. By linking and referring to the payment processing table and the various tables described above, in the electrical charging service of the present embodiment, it is possible to perform the payment process in which the provision fee for the power supply amount is paid to the disposer (parking place manager).

Furthermore, the storage section (DB) 104 may store a fee-charge processing table in which user information such as the user ID and information (billing destination information of the usage fee, etc.) used in a process (fee-charge process) necessary for collecting the usage fee for the power supply amount to charge the vehicle 30 of the user is associated with information on the energy supply target regarding the vehicle, the battery, etc. A record is added to this fee-charge processing table when the user 50 is newly registered to the electrical charging service of the present embodiment. By linking and referring to the fee-charge processing table and the various tables described above, in the electrical charging service of the present embodiment, it is possible to perform the fee-charge process in which the usage fee for the power supply amount is charged to the user.

For example, when using the SoC data as the supply amount information, battery information table showing the correspondence between the identification information of the battery 31 and the full charge capacity is stored in the storage section (DB) 104.

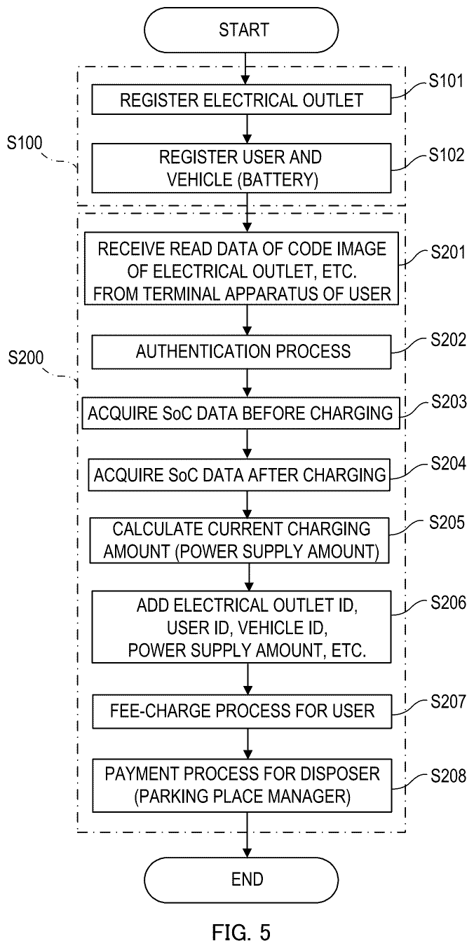

FIG. 5 is a flowchart illustrating an example of a service management process in the service management server 100 according to the present embodiment.

In FIG. 5, the service management process of the present embodiment includes an advance preparation phase (S100) and an operation phase (S200).

In the advance preparation phase (S100), when the service management server 100 receives a request of an electrical outlet registration for the electrical charging service from the disposer (provider) of the electrical outlet 20, such as the parking place manager, it acquires and stores information regarding the request. For example, when an operator inputs data regarding the electrical outlet 20 of the disposer (parking place manager), the service management server 100 creates the electrical outlet management table shown in Table 2 and the payment processing table described above (S101). Specifically, when the request of the electrical outlet registration is received, the operator uses an input apparatus (provision-side registration-information acquisition section) such as a keyboard or a touch panel for inputting data into the service management server 100 to input data of the provision-side registration information including the provider information and the information of the energy output section. As a result, in the service management server 100, a table that associates the provision-side registration information input via the input apparatus with the output-section identification information (electrical outlet ID, etc.) for identifying the energy output section is stored in a database of the storage section 104. By managing such a table, it is possible to perform the appropriate payment process for a plurality of providers with the provision fee according to the amount of electric power supplied from each electrical outlet 20 (energy output section).

It is noted that the provision-side registration-information acquisition section in the service management server 100 may be configured to receive and acquire the provision-side registration information transmitted from a provider's terminal apparatus via the communication network instead of data input by the operator.

Further, when the user 50 who uses the electrical charging service (energy supply service) requests for the use of the electrical charging service using the terminal apparatus 51, the service management server 100 receives and acquires a new registration data (use-side registration information) including information (user information) of the user 50 and the terminal apparatus 51, and information (information of the energy supply target) of the supply target (vehicle 30 and battery 31) from the terminal apparatus 51. The terminal communication section 101 that receives this new registration data functions as the provision-side registration-information acquisition section.

In the service management server 100, a table in which the received use-side registration information, the supply-target identification information (vehicle ID and battery ID) that identifies the energy supply target, and information (terminal ID) of the mobile terminal apparatus used by the user when using the electrical charging service are associated with each other is stored in a database of the storage section 104. As a result, the user management table shown in Table 3, the vehicle management table shown in Table 4, and the above-mentioned fee-charge processing table are created (S102).

Next, in the operation phase (S200), when the user 50 charges the battery 31 of the vehicle 30 by receiving the power supply from the registered electrical outlet 20, the user 50 first operates the terminal apparatus 51 to start an application (power usage app) for using the electrical charging service. Then, the user uses the terminal apparatus 51 to image and read the code image 21 including the identification information of the electrical outlet 20, and selects “My Car” from a menu selection displayed on a display screen of the terminal apparatus 51. Through this operation, the identification information of the user 50 (or terminal apparatus 51), the read data of the code image 21, and the identification information of the vehicle 30 (or battery 31) pre-registered as the “My Car” in the terminal apparatus 51 are transmitted from the terminal apparatus 51 to the service management server 100. Thereby, the service management server 100 receives the identification information of the user 50 (or terminal apparatus 51), the read data of the code image 21, and the identification information of the vehicle 30 (or battery 31) from the terminal apparatus 51 of the user 50 (S201).

Next, the service management server 100 uses the identification information of the user 50 (or terminal apparatus 51) received from the terminal apparatus 51 and the identification information of the vehicle 30 (or battery 31) to perform an authentication process about a combination of the identification information of the user 50 (or terminal apparatus 51) and the identification information of the vehicle 30 (or battery 31) (S202).

After completing the authentication process, the service management server 100 sends a request of the SoC data (supply amount information) regarding the vehicle 30 to the vehicle management server 300 based on the received identification information of the user 50 (or terminal apparatus 51) and the received identification information of the vehicle 30 (or battery 31). As a result, the latest supply amount information (SoC data before charging) regarding the vehicle 30 is acquired from the vehicle management server 300 to the service management server 100 via the communication network 60 (S203).

Thereafter, the battery 31 of the vehicle 30 is charged with the electric power supplied from the electrical outlet 20, and when the charging is completed, the power usage information (for example, battery identification information, amount of electric power (SoC data), power-charging start time, and power-charging end time) used to charge the battery 31 of the vehicle 30 from the electrical outlet 20 is transmitted to the vehicle management server 300 by the vehicle 30 in response to a request from the terminal apparatus 51 of the user 50 or autonomously. As a result, the SoC data after charging is registered in the vehicle management server 300.

Further, when charging is completed, a charging completion notification including the identification information of the user 50 (or terminal apparatus 51) and the identification information of the vehicle 30 (or battery 31) is transmitted from the user's terminal apparatus 51 to the service management server 100. Upon receiving the charging completion notification, the service management server 100 sends a request of the SoC data (supply amount information) regarding the vehicle 30 to the vehicle management server 300 based on the identification information of the user 50 (or terminal apparatus 51) and the identification information of the vehicle 30 (or battery 31). As a result, the latest supply amount information (SoC data after charging) regarding the vehicle 30 is acquired from the vehicle management server 300 to the service management server 100 via the communication network 60 (S204).

In this way, the service management server 100 that received the SoC data before charging and the SoC data after charging refers to the battery information table in the storage section (DB) 104 to obtain the full charge capacity of the battery 31. Then, the remaining power amount of the battery 31 before charging is calculated from the SoC data before charging and the full charge capacity, and the remaining power amount of the battery 31 after charging is calculated from the SoC data after charging and the full charge capacity. Thereafter, the remaining power amount before charging is subtracted from the remaining power amount after charging to calculate the power supply amount used for the current charging (S205).

Next, the service management server 100 refers to the electrical outlet management table of Table 2 described above based on the read data of the code image, and specifies the identification information of the electrical outlet 20. Furthermore, the service management server 100 stores in the storage section (DB) 104 such that the identification information of the electrical outlet 20 (electrical outlet ID), the identification information of the user 50 or terminal apparatus 51 (user ID, terminal ID), the identification information of the supply target (vehicle ID or battery ID), and a current charging amount (power supply amount) calculated in the process of Step S205 are added to the power usage transaction table (power usage register) of Table 1 described above in association with each other (S206).

The service management server 100 can manage the electrical charging service that involves the power supply through the electrical outlet by referring to the power usage transaction table (power usage register) as shown in Table 1.

In the present embodiment, the service management server 100 refers to the power usage transaction table (power usage register) to perform a process (fee-charge process) necessary for fee-charging the usage fee of the electric power used by the vehicle 30 via the electrical outlet 20 to at least one of the user 50, the supply target (vehicle 30 or battery 31) and the terminal apparatus 51 (S207). In this fee-charge process, for example, the total amount of electric power supplied to each user during a predetermined period (for example, one month) is calculated, and this is multiplied by a unit price of the usage fee to calculate the usage fee to be collected from each user. Then, with reference to the fee-charge processing table in the storage section 104, the fee-charge process necessary to collect the usage fee from each user is performed.

Herein, the variable parameter information other than the supply amount information (information on the charging time (power-charging end time—power-charging start time), information on the power supply speed (power supply amount per unit time), information on the type of electric power (energy) generation method, information on the type of vehicle 30 (energy supply target), etc.) may be taken into account to calculate the usage fee.

There is no particular restriction on a method of collecting the usage fee from the user as long as the usage fee is collected according to the amount of electric power supplied to the user's vehicle 30 from the electrical outlet 20. For example, a completely pay-per-amount system may be used, or a flat-rate system may be used in which a fixed fee is charged until a specified amount of electric power is supplied. The business-operator that collects the usage fee from the user may be the service management business-operator that operates the service management server 100, or another business-operator that collects the usage fee upon commission from the service management business-operator.

In the present embodiment, the service management server 100 refers to the power usage transaction table (power usage register) to perform a process (payment process) necessary for paying the provision fee of the electric power provided to the vehicle 30 via the electrical outlet 20 to the disposer (parking place manager) of the electrical outlet 20 (S208). In this payment process, for example, the total power supply amount corresponding to the electrical outlet 20 of each disposer during a predetermined period (for example, one month) is calculated, and this is multiplied by a unit price of the provision fee to calculate the provision fee to be paid to each disposer. Then, with reference to the payment processing table in the storage section 104, the payment process necessary to pay the provision fee to each disposer is performed.

Herein, the variable parameter information other than the supply amount information (information on the charging time (power-charging end time—power-charging start time), information on the power supply speed (power supply amount per unit time), information on the type of electric power (energy) generation method, information on the type of vehicle 30 (energy supply target), etc.) may be taken into account to calculate the provision fee.

As described above, in the present embodiment, the service management server 100 uses the fee-charge processing section 105 to perform the fee-charge process necessary for fee-charging the user 50 the usage fee of electric power calculated from the supply amount information (variable parameter information) received by the server communication section 102. As a result, the service management business-operator who operates the service management server 100 can provide the service that collects the appropriate usage fee according to the amount of electric power (power supply amount) receiving by the power supply from the user 50 who received the power supply from the electrical outlet 20, as the energy output section, registered in the electrical charging service (energy supply service) of the present embodiment.

In the present embodiment, the service management server 100 uses the payment processing section 106 to perform the payment process necessary for paying, to the parking place manager as the provider, the provision fee of electric power calculated from the supply amount information (variable parameter information) received by the server communication section 102. As a result, the service management business-operator who operates the service management server 100 can provide the electrical charging service (energy supply service) in which the parking place manager can receive the appropriate provision fee according to the amount of electric power (power supply amount) provided from the electrical outlet 20.

In the present embodiment, as described above, the electrical outlet 20 as the energy output section may be a shared electrical outlet (such as a general-purpose electrical outlet) that can be used not only by predetermined specific users (users who are registered in the electrical charging service) but also by unspecified general users (users who are not registered in the electrical charging service (energy supply service) of the present embodiment) other than the specific users. Using such a shared electrical outlet as the energy output section of the service management system of the present embodiment makes procedures such as permission for disposing easier than when disposing the electrical outlet that can be used only by the specific user, and this contributes to increase the number of energy output sections that can be used in electrical charging services (energy supply services) and expand the disposing area thereof.

However, the shared electrical outlet is usually equipped with the power meter that detects the supply amount information of the electric power supplied from the electrical outlet, and such a detection section detects all the supply amount information of the electric power supplied from the electrical outlet at once without distinguishing between users. Therefore, with a system that detects the supply amount information with the detection section installed on the shared electrical outlet side, it is not possible to detect the supply amount information by distinguishing the specific users from the general users, and it is difficult to manage the provision and use of the electric power (energy) that is used by providing to the specific users. Therefore, when using the shared electrical outlet, it is necessary to distinguish the amount of electric power supplied from the electrical outlet to the specific users from that of the general users.

According to the present embodiment, the amount of electric power supplied from the electrical outlet 20 to the vehicle 30 of the user 50 is grasped based on the supply amount information detected by the detection section 33 provided in the vehicle 30. Therefore, even when using the shared electrical outlet, the amount of electric power supplied from the electrical outlet 20 to the vehicle 30 of the user 50 (specific user) can be grasped separately from that of other users (general users, etc.). Furthermore, in this case, it is no need that the disposer (parking place manager, etc.) of the shared electrical outlet disposes a new equipment for detection to distinguish the amount of electric power supplied from the electrical outlet 20 to the specific user from that of other users (general users, etc.). Therefore, for the parking place manager, equipment costs (introduction costs) can be reduced even when the shared electrical outlet is used in the electrical charging service (energy supply service).

In the present embodiment, an electrical outlet (energy output section) disposed in a common area such as a common part of an apartment or a parking place of a shopping center may be used as the electrical outlet (energy output section) that can be used in the electrical charging service (energy supply service), and this also contributes to increase the number of energy output sections that can be used in electrical charging services (energy supply services) and expand the disposing area thereof. However, such a common area is often equipped with the detection section that detects supply amount information of the electric power (energy) supplied within the common area, and such a detection section detects a total amount of electric power supplied within the common area. Therefore, it is difficult for the detection section provided in the common area to grasp only the amount of electric power supplied from the electrical outlet disposed in such a common area.

In the present embodiment as well, the power meter 83 measures all the amount of electric power in the parking place 80, which is the common area including the electrical outlet 20, the gate apparatus 82 and various power usage equipment 85, that is the total amount of the amount of electric power supplied from the electrical outlet 20 to the vehicle 30 of the user 50, and the amount of other electric power supplied to the gate apparatus 82 and various power usage equipment 85, at once. Then, the parking place manager pays the electric power company the electric power fee corresponding to this total amount. In this case, in order to pay the provision fee for the amount of electric power supplied from the electrical outlet 20 to the vehicle 30 of the user 50 to the parking place manager (provider) by the service management business-operator, it is necessary to grasp only the amount of electric power supplied from the electrical outlet 20 to the vehicle 30 of the user 50, separately from the power meter 83.

According to the present embodiment, the power supply information (energy supply information) regarding the power supply that supplies from the electrical outlet 20 to the vehicle 30 of the user 50 is grasped based on the power usage information (for example, battery identification information, amount of electric power, power-charging start time, power-charging end time) detected by the detection section 33 provided in the vehicle 30. Therefore, even if only the equipment (power meter 83) that measures all the amount of electric power in the parking place 80 including the electrical outlet 20, the gate apparatus 82, and various power usage equipment 85 at once is equipped, the amount of electric power supplied from the electrical outlet 20 to the vehicle 30 of the user 50 can be grasped. Therefore, in the present embodiment, in a case where the parking place manager receives the provision fee for the power supply of the user 50 who received the power supply from the electrical outlet 20, it is no need that a new equipment for detecting the amount of electric power supplied from the electrical outlet 20 to the vehicle 30 of the user 50 is disposed. Therefore, for the parking place manager, equipment costs (introduction costs) can be reduced when registering as an energy provider of the electrical charging service (energy supply service).

Further, for the parking place manager, there is no need for complicated procedures for disposing the new equipment as described above, and a registration of the energy provider in the electrical charging service (energy supply service) is facilitated. For example, if the parking place 80 is a common part of a condominium, and the parking place manager is a management association of the condominium, disposing the new equipment as described above in the common part needs procedures such as obtaining consent from a lot of sectional ownership in the condominium, and requires extremely complicated procedures. According to the present embodiment, such complicated procedures are not required, so that a registration of the common electrical outlet 20 provided in the common part of the condominium as the electrical outlet (energy output part) for the electrical charging service (energy supply service) is facilitated.

Furthermore, according to the service management system of the present embodiment, a collection (fee-charge) of the usage fee from the user and a payment of the provision fee to the provider (parking place manager) are performed by the service management business-operator that operates the electrical charging service (energy supply service). Therefore, the provider (parking place management business-operator) does not need to prepare and manage equipment necessary for collecting the usage fee from the user, or perform the necessary fee-charge process, so the electrical charging service (energy supply service) provided by the service management system of the present embodiment is highly convenient for the parking place management business-operator. Therefore, since it is easy for the provider (parking place management businesses operator) to register as the provider, it is expected that the number of providers (parking place management business-operators) that register to the electrical charging services (energy supply services) increases, and this facilitates to increase the number of energy output sections (electrical outlets 20) that can be used by the users and expand the disposing area thereof.

Moreover, the detection section 33 that detects the power usage information (for example, SoC data, battery identification information, amount of electric power, power-charging start time, and power-charging end time) for grasping the power supply information regarding the power supply that supplies from the electrical outlet 20 to the vehicle 30 of the user 50 is an equipment that is provided in most existing vehicles (energy supply target) 30. Therefore, the user 50 is not burdened with additional costs for the detection section 33.

In recent years, various information including the power usage information (for example, SoC data, battery identification information, amount of electric power, power-charging start time, and power-charging end time) detected by the detection section 33 provided in the vehicle 30 is accumulated in the vehicle management server 300 of each vehicle manufacturer, and used for various vehicle services. The service management server 100 of the present embodiment does not acquire the power usage information detected by the detection section 33 provided in the vehicle 30 from each vehicle 30 individually, but acquires it from the vehicle management server 300 of the vehicle manufacturer. According to this, the service management server 100 can acquire the power usage information detected by the detection section 33 provided in the vehicle 30 using existing devices and equipment, so that there is no need to newly install a device that transmits the power usage information to the service management server 100 in each vehicle 30 of each user 50. Therefore, the cost burden on the user 50 is further reduced.

On the other hand, since it is assumed that there are users who do not use a service in which the power usage information detected by the detection section 33 provided in the vehicle 30 is accumulated in the vehicle management server 300 of the vehicle manufacturer, a new device that transmits the power usage information to the service management server 100 may be newly installed in the vehicle 30 of the user 50. In this case, for example, a transmission device as a transmission section that can acquire the power usage information (such as SoC data) detected by the detection section 33 of the vehicle 30, and transmit it to the service management server 100 may be connected to a connector for the OBD2 (On Board Diagnosis second generation) provided in the vehicle 30.

Further, in the present embodiment, the identification information of the user 50 or the terminal apparatus 51, and the identification information of the vehicle 30 as the supply target to which the electric power is supplied from the electrical outlet 20, as the supply-target identification information, are received and acquired from the terminal apparatus 51 of the user 50 by the service management server 100, but the supply-target identification information may be acquired by other methods. For example, the gate apparatus 82 disposed at the entrance/exit gate of the parking place 80 may be provided with a function of acquiring the identification information of the vehicles 30 entering and exiting the parking place 80, and the service management server 100 may receive the identification information of the vehicles 30 as the supply-target identification information from the gate apparatus 82. In this case, for example, a license plate (vehicle registration number certificate) of the vehicle 30 passing through the entrance/exit gate is imaged using an imaging apparatus such as a camera provided at the gate apparatus 82, and the vehicle registration number of the vehicle 30 recognized from the obtained image is acquired as the identification information. In addition, the identification information of the vehicle received from an ETC (Electronic Toll Collection System) in-vehicle equipment installed in the vehicle may be acquired.

In the embodiment described above, the terminal apparatus 51 of the user 50 is used to transmit information such as the identification information of the user and the identification information of the provider, to the service management server 100, but the external communication section 32 mounted on the vehicle 30 may be used instead of the terminal apparatus 51. Further, in the embodiment described above, the external communication section 32 mounted on the vehicle 30 is used to transmit information such as the power usage information (power supply information), but the terminal apparatus 51 of the user 50 may be used instead of such an in-vehicle external communication section 32.

In addition, the above-mentioned usage fee charged to the user and the provision fee paid to the provider such as the parking place manager may be calculated by taking other variable parameter information into consideration instead of or together with the power usage information (power supply information). For example, even if the power supply amount is the same, the usage fee and the provision fee may be changed depending on other variable parameter information. In addition to the above-mentioned information, this variable parameter information includes, for example, an attribute of the user (difference in a fee paid for the service, difference in service grade, difference in age of the user, difference in region to which the user belongs, etc.), and an attribute of the vehicle 30 as the energy supply target (difference in the vehicle manufacturer, difference in-additional service related to the vehicle 30, etc.). In addition, the variable parameter information includes, for example, information on the type of energy output from the energy output section (difference in an energy source, whether a specified clean energy or not, etc.), and the type of energy output section (difference in a supply speed of energy supplied from the provider's energy output section to the user's energy supply target (whether the fast-charging or not), etc.).

### Modified Example

Next, a modified example of the service management system in the embodiment described above will be described.

It is noted that, in the following description, points that are different from the above-described embodiment will be mainly explained, and descriptions similar to the above-described embodiment will be omitted.

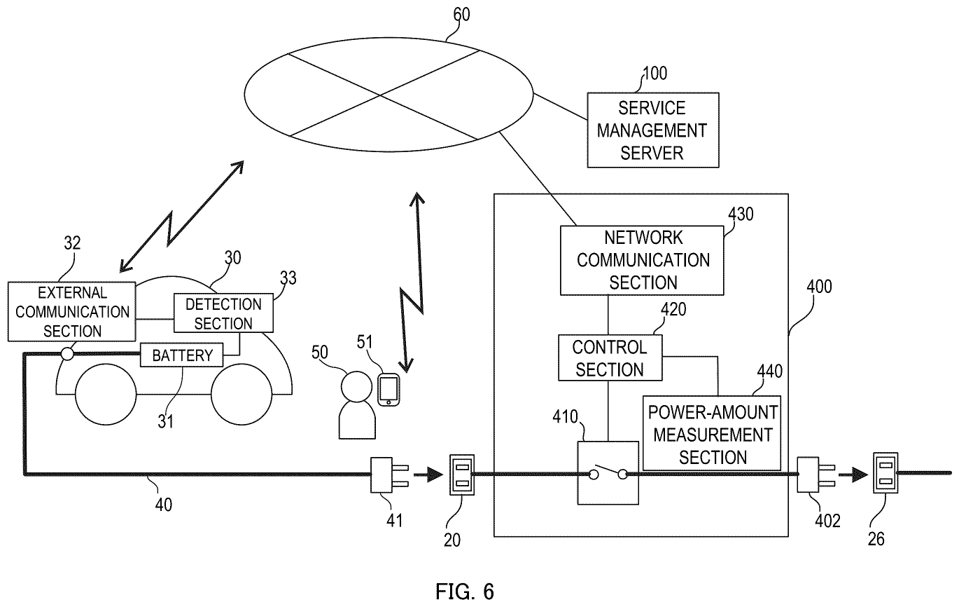

FIG. 6 is an explanatory diagram showing an example of a main configuration of a service management system according to the present modified example.

In the management system of the present modified example, a detection section that detects the supply amount information is installed in a power output apparatus 400 as an energy output apparatus that includes the electrical outlet 20 as the energy output section. This power output apparatus 400, like the charging stand 25 of the embodiment described above, receives the power supply from the power distribution equipment 210 of the electric power company via the power line. The power output apparatus 400 of the present example also functions as a power supply control apparatus that controls the power supply to the battery 31 of the vehicle 30 via the electrical outlet 20.

The power output apparatus 400 includes a general-purpose plug 402 that is connected to the general-purpose electrical outlet 26 on the power distribution equipment 210 side (the power meter 83 side) shown in FIG. 1. Further, the power output apparatus 400 includes the electrical outlet 20 as the energy output section, and can supply the electric power to the battery 31 of the vehicle 30 by inserting and connecting the plug 41 into the electrical outlet 20.

The power output apparatus 400 also includes a switch section 410 as an opening/closing means for opening/closing the path of power supply from the electrical outlet 20 to the battery 31, a control section 420 as a control means for controlling the switch section 410, a network communication section 430 as a communication means that communicates with the service management server 100 etc. via the communication network 60, and a power-amount measurement section 440 as the detection section that detects the power supply amount during charging.

The switch section 410 can be configured with, for example, a switch having a normally open relay contact.

The control section 420 can be configured with, for example, a general-purpose microcomputer configured with such as a CPU, a dedicated IC circuit element, or the like. The control section 420 may also include a storage section as a storage means including a semiconductor memory such as a RAM or a ROM, a magnetic disk, etc., and may be configured to read a predetermined program stored in the storage section, and according to the program, to perform a transmitting/receiving process of data and commands, a data processing of a user authentication, a control of the switch section, etc. Further, the control section 420 may be configured by a first control section connected to the switch section 410 and a second control section controlled by the service management server 100 via the communication network 60. In this case, a control is performed between the first control section and the second control section via, for example, an API (Application Programming Interface).

The control section 420 includes a timer as a time measurement means. For example, when receiving an authentication result indicating that the authentication process is successful from the service management server 100 or when receiving a connection request from the terminal apparatus 51 via the communication network 60, the timer presets a usage time included in the connection request, then controls the switch section 410 to be turned ON (relay closed), and starts the timer function at the same time as the power supply to the battery 31 starts. Then, when the usage time expires and the time is up, a time-up signal is output. Based on this time-up signal, the control section 420 controls the switch section 410 to be turned OFF (relay opened), and ends the power supply to the battery 31. It is noted that the control section 420 may perform the authentication process performed by the service management server 100.

The network communication section 430 functions as the transmission section that transmits the provision-side identification information such as the electrical outlet ID and the supply amount information (variable parameter information) such as the amount of electric power output from the electrical outlet 20 to the battery 31 of the vehicle 30, to the service management server 100, etc. via the communication network 60. The network communication section 430 may be configured to communicate via a wired communication line such as an optical line, or may be configured using a wireless communication module to communicate via a wireless communication line. A communication via the wireless communication line may be, for example, a communication via a cellular mobile communication network of the fourth generation, the fifth generation, or a communication via a wireless LAN such as Wi-Fi.

The power-amount measurement section 440 functions as the detection section that detects the amount of electric power (power supply amount) used to charge the battery 31 from the electrical outlet 20. As the power-amount measurement section 440, for example, an induction type power meter, an electronic type power meter, or the like can be used. The power usage information (power supply information) detected by the power-amount measurement section 440 is transmitted to the control section 420, and the control section 420 transmits the power usage information (power supply information) from the network communication section 430 to the service management server 100 via the communication network 60 at a predetermined timing.

In the present modified example, the service management server 100 acquires the power usage information (power supply information) that is necessary for calculating the usage fee to be charged to the user 50 and the provision fee to be paid to the parking place manager directly from the power output apparatus 400. As a result, even without acquiring the SoC data from the vehicle management server 300 of the vehicle manufacturer, it is possible to appropriately calculate the usage fee and the provision fee according to the amount of electric power supplied from the electrical outlet 20 to the battery 31. Therefore, according to the present modified example, there is no need to cooperate with the vehicle management server 300 of the vehicle manufacturer, thereby it possible to provide an electrical charging service that is easy to use even for users who do not use a service in which vehicle information such as the power usage information is accumulated in the vehicle management server 300 of the vehicle manufacturer.

Moreover, in the power output apparatus 400 of the present modified example, the parking place manager (provider) can start the electrical charging service similar to the embodiment described above by simply inserting and connecting the general-purpose plug 402 of the power output apparatus 400 to the general-purpose electrical outlet 26 attached to an electrical outlet disposing location such as the parking place 80, where the electrical outlet 20 as the energy output section is disposed. Therefore, in the present modified example, as in the above-described embodiment, the registration of the parking place manager (provider) to the electrical charging service (energy supply service) is facilitated, and the increase in the number of energy output sections (electrical outlets 20) that can be used by the users and the expansion of the disposing area thereof is facilitated.

It is noted that process steps and configuration elements such as information processing apparatuses, gate apparatuses, in-vehicle apparatuses of vehicles, terminal apparatuses and servers described in the present specification can be implemented with various means. For example, these process steps and configuration elements may be implemented with hardware, firmware, software, or a combination thereof.

With respect to hardware implementation, means such as processing sections or the like used for establishing the foregoing steps and configuration elements in entities (for example, computer apparatus, server, gate apparatus, in-vehicle apparatus of vehicle, terminal apparatus (user equipment, mobile station, communication terminal), hard disk drive apparatus, or optical disk drive apparatus) may be implemented in one or more of an application-specific IC (ASIC), a digital signal processor (DSP), a digital signal processing device (DSPD), a programmable logic device (PLD), a field programmable gate array (FPGA), a processor, a controller, a microcontroller, a microprocessor, an electronic device, other electronic unit, computer, or a combination thereof, which are designed so as to perform a function described in the present specification.

With respect to the firmware and/or software implementation, means such as processing sections or the like for using to establish the foregoing configuration elements may be implemented with a program (for example, a code such as a procedure, a function, a module, an instruction, etc.) for performing a function described in the present specification. In general, any computer/processor readable medium of clearly materializing the code of firmware and/or software may be used for implementation of means such as processing sections and so on for establishing the foregoing steps and configuration elements described in the present specification. For example, in a control apparatus, the firmware and/or software code may be stored in a memory and executed by a computer or processor. The memory may be implemented within the computer or processor, or outside the processor. Further, the firmware and/or software code may be stored in, for example, a medium capable being read by a computer or processor, such as a random-access memory (RAM), a read-only memory (ROM), a non-volatility random-access memory (NVRAM), a programmable read-only memory (PROM), an electrically erasable PROM (EEPROM), a FLASH memory, a floppy (registered trademark) disk, a compact disk (CD), a digital versatile disk (DVD), a magnetic or optical data storage section, or the like. The code may be executed by one or more of computers and processors, and a certain aspect of functionalities described in the present specification may be executed by a computer or processor.

The foregoing medium may be a non-temporary recording medium. The foregoing code of the program may be readable and executable by a computer, processor, or other device or apparatus machine, and its format is not limited to a specific format. For example, the foregoing code of the program may be any of source code, object code, and binary code, or may be a mixture of two or more of these codes.

The description of embodiments disclosed in the present specification is provided so that the present disclosures can be produced or used by those skilled in the art. Various modifications of the present disclosures will be readily apparent to those skilled in the art and general principles defined in the present specification can be applied to other variations without departing from the spirit and scope of the present disclosures. Therefore, the present disclosures should not be limited to examples and designs described in the present specification and should be recognized to be in the broadest scope corresponding to principles and novel features disclosed in the present specification.

### REFERENCE SIGNS LIST

10: service management system
20: electrical outlet
21: code image
22, 23: identification auxiliary image
25: power-charging stand
26: general-purpose electrical outlet
30: vehicle
31: battery
32: external communication section
33: detection section
40: power cable
41: plug
50: user
51: terminal apparatus
60: communication network
80: parking place
81: entrance/exit gate
82: gate apparatus
83: power meter
85: power usage equipment
100: service management server
101: terminal communication section
102: server communication section
103: management processing section
104: storage section
105: fee-charge processing section
106: payment processing section
200: power management apparatus
210: power distribution equipment
300: vehicle management server
400: power output apparatus
402: general-purpose plug
410: switch section
420: control section
430: network communication section
440: power-amount measurement section

1. An information processing apparatus for managing an energy supply service, comprising:
a provision-side registration-information acquisition section for acquiring provision-side registration information that includes information on a provider who owns or manages an energy output section capable of being used for the energy supply service and information on the energy output section;
a use-side registration-information acquisition section for acquiring use-side registration information that includes information on a user who uses, owns, or manages an energy supply target capable of using an energy supplied by the energy supply service and information on the energy supply target;
a storage section for storing the provision-side registration information and output-section identification information for identifying the energy output section in association with each other, and storing the use-side registration information, supply-target identification information for identifying the energy supply target, and information on a mobile terminal apparatus used by the user during a use of the energy supply service in association with each other;
a usage-start-information receiving section for receiving usage start information that includes the output-section identification information corresponding to the energy output section that supplies the energy to the energy supply target from the user's mobile terminal apparatus at the time of starting the use of the energy supply service;
a supply-information acquisition section for acquiring energy supply information regarding an energy supply to the energy supply target of the user from the energy output section of the provider when the energy supply service is used;
a payment processing section for referring to information stored in the storage section based on the energy supply information acquired by the supply-information acquisition section, and performing a process necessary for paying to the provider with respect to a fee for providing the energy supply service from the energy output section to the energy supply target; and
a fee-charge processing section for referring to information stored in the storage section based on the energy supply information acquired by the supply-information acquisition section, and performing a process necessary for fee-charging to the user with respect to a usage fee of the energy supply service from the energy output section to the energy supply target.

2. The information processing apparatus according to claim 1, wherein the energy output section receives the energy from an energy business-operator to which an energy fee is paid from the provider, based on a total amount of an amount of the energy supplied from the energy output section to the energy supply target and an amount of the energy supplied from other than the energy output section to other supply targets other than the energy supply target, and supplies the energy to the energy supply target.

3. The information processing apparatus according to claim 1 or 2, wherein the supply-information acquisition section acquires, as the energy supply information, at least use-side identification information of a side that uses the energy, provision-side identification information of a side that provides the energy, and variable parameter information that vary the fee for providing and the usage fee.

4. The information processing apparatus according to claim 3, wherein the supply-information acquisition section receives and acquires the variable parameter information from a management apparatus that manages the energy supply target.

5. The information processing apparatus according to claim 3, wherein the supply-information acquisition section receives and acquires the variable parameter information from the energy supply target.

6. The information processing apparatus according to claim 3, wherein the supply-information acquisition section receives and acquires the variable parameter information from an energy output apparatus including the energy output section.

7. The information processing apparatus according to any one of claims 3 to 6, wherein the supply-information acquisition section receives and acquires the use-side identification information and the provision-side identification information from the user's terminal apparatus.

8. A system for managing an energy supply service, comprising:
the information processing apparatus according to any one of claims 1 to 7; and
a transmission apparatus for transmitting the energy supply information acquired by the supply-information acquisition section of the information processing apparatus, to the information processing apparatus.

9. A method for managing an energy supply service, comprising:
acquiring provision-side registration information that includes information on a provider who owns or manages an energy output section capable of being used for the energy supply service and information on the energy output section;
acquiring use-side registration information that includes information on a user who uses, owns or manages an energy supply target capable of using an energy supplied by the energy supply service and information on the energy supply target;
storing the provision-side registration information and output-section identification information for identifying the energy output section in association with each other, and storing the use-side registration information, supply-target identification information for identifying the energy supply target, and information on a mobile terminal apparatus used by the user during a use of the energy supply service in association with each other;
receiving usage start information that includes the output-section identification information corresponding to the energy output section that supplies the energy to the energy supply target from the user's mobile terminal apparatus at the time of starting the use of the energy supply service;
acquiring energy supply information regarding an energy supply to the energy supply target of the user from the energy output section of the provider when the energy supply service is used;
referring to the stored information based on the energy supply information, and performing a process necessary for paying to the provider with respect to a fee for providing the energy supply service from the energy output section to the energy supply target; and
referring to the stored information based on the energy supply information, and performing a process necessary for fee-charging to the user with respect to a usage fee of the energy supply service from the energy output section to the energy supply target.
